(19) United States
(12) Patent Application Publication
(10) Pub. No.: US 2025/0289726 A1
(43) Pub. Date: Sep. 18, 2025

(54) METHOD FOR PREPARING CERIUM (III) HYDROXY CARBONATE

(71) Applicant: Rohm and Haas Company, Collegeville, PA (US)

(72) Inventors: Timothy P. Moneypenny, Pottstown, PA (US); Keith A. Alderfer, Telford, PA (US); James C. Bohling, Lansdale, PA (US); Juan F. Callejas, Audubon, PA (US)

(21) Appl. No.: 18/863,432

(22) PCT Filed: May 15, 2023
(86) PCT No.: PCT/US2023/022205

§ 371 Date: Nov. 6, 2024

Related U.S. Application Data
(60) Provisional application No. 63/344,952, filed on May 23, 2022.

(51) Int. Cl. C01F 17/247

(52) U.S. Cl. CPC C01F 17/247

(57) ABSTRACT

The present invention relates to a process for preparing cerium (III) hydroxy carbonate by contacting a cerium (III) nitrate with urea at elevated temperatures and in the substantial absence of a polymer dispersant.

### BACKGROUND OF THE INVENTION

The present invention relates to a method for preparing cerium (III) hydroxy carbonate, which is useful in improving tint retention and attenuating undesirable color change in coatings prepared from paint formulations. Cerium (III) carbonate has recently been reported to be an effective additive for improving tint retention and reducing color change in paint coatings. (See US 2021/1888227 A1 (Bohling).) Bohling discloses that a 20 wt. % aqueous dispersion of ligand-capped cerium (III) carbonate particles having a z-average particle size of 110±5 nm can be prepared by admixing a solution of ammonium cerium (III) nitrate and a solution of a chelating agent (EDTA) and ammonium carbonate, followed by centrifugation and supernatant removal. (Pg. 4, lines 4-6, and pg. 5, lines 1-6.) The chelating agent is believed to “promote the formation of the nanodisperse particles while stabilizing the particles against agglomeration.” (Pg. 3, lines 27-29.)

U.S. Pat. No. 8,637,153 B2 (Cho) discloses (col. 10, lines 5-29) a method for preparing a crystalline cerium (III) carbonate by first contacting a hydrate of Ce(NO₃)₃ with urea at a temperature in the range of from 80° C. to 100° C., then adding 10 to 30 weight percent of a polymer dispersant such as polyethylene glycol or polyacrylic acid to the admixture. (Col. 10, lines 22-24; and col. 5, lines 61-65.) Water is then removed, and the temperature is raised to 140° C. After completion of the reaction, the product may be washed with water to remove unreacted urea and the polymer dispersant, then dried to isolate a crystalline solid. The volume mean diameter of experimentally prepared particles are reported to be in the range of from 75 nm to 90 nm (Col. 12, Table 1); in general, Cho discloses that particle sizes are controllable by varying the amounts and molecular weights of the polymer dispersants. (Col. 8, lines 19-30.) The cerium (III) carbonate is then used as a precursor to prepare uniform sized cerium oxide nanoparticles. (Col. 13, lines 3-8.)

There is a need in the field of cerium (III) carbonate chemistry to design a more sustainable way of preparing a carbonate of cerium (III), one that does not require chelating agents or non-biodegradable polymer dispersants.

### SUMMARY OF THE INVENTION

The present invention addresses a need in the art by providing a process comprising the step of contacting at a temperature in the range of from 110° C. to 200° C., and in the substantial absence of a polymer dispersant, a cerium (III) nitrate and urea to form cerium (III) hydroxy carbonate.

The process of the present invention is useful for preparing an additive that reduces color fading and attenuates unwanted color change in coatings arising from paint.

### DETAILED DESCRIPTION OF THE INVENTION

The present invention is a process comprising the step of contacting at a temperature in the range of from 110° C. to 200° C., and in the substantial absence of a polymer dispersant, a cerium (III) nitrate and urea to form cerium (III) hydroxy carbonate.

As used herein, the term “substantial absence of a polymer dispersant” refers to less than 5, preferably less than 1, more preferably less than 0.1, and most preferably 0 weight percent, based on the weight of cerium (III) nitrate, of a polymer dispersant in a polymer melt of cerium (III) nitrate and urea. More particularly, a polymer dispersant refers to polyethylene glycol; a polymer functionalized with carboxylic acid groups such as polyacrylic acid and polymethacrylic acid; polyvinyl alcohol; or polyvinylpyrrolidone; or a combination thereof.

Preferably, the reaction is also conducted in the substantial absence of a chelating agent that is capable of forming a capping ligand with the cerium (III) hydroxy carbonate. The term “substantial absence of a chelating agent that is capable of forming a capping ligand with the cerium (III) hydroxy carbonate” refers to less than 1, preferably less than 0.5, more preferably less than 0.1, and most preferably 0 weight percent, based on the weight of cerium (III) nitrate, of the chelating agent, which is a) an amine carboxylic acid or a salt thereof, such as ethylene diamine tetraacetic acid (EDTA), ethylene diamine diacetic acid (EDDA), and nitrolotriacetic acid (NTA); and b) an amine phosphonic acid or a salt thereof such as aminotrimethyl phosphonic acid (ATMP), 6-amino-2-[bis(carboxymethyl)amino]hexanoic acid, and N-(phosphonomethyl)iminodiacetic acid (PIDA).

As used herein, “a cerium (III) nitrate” refers to an anhydrous or a hydrated cerium (III) nitrate. The cerium (III) nitrate is preferably used as a hydrate, more particularly a hexahydrate. The reaction of cerium (III) nitrate and urea is most preferably carried out under neat conditions, i.e., solvent-free and water-free, other than water arising from the hydrate. It is also preferred that the reaction be carried out with the combination of cerium (III) nitrate and urea comprising at least 95, or at least 98, or at least 99 or 100 weight percent of the components in the initial reaction mixture.

The mole-to-mole ratio of the cerium (III) nitrate to urea is preferably in the range of from 1:3, or from 1:4, or from 1:5, to 1:20, or to 1:10, or to 1:8. The reaction is carried out at a temperature in the range of from 110° C., or from 125° C., or from 140° C., to 200° C., or to 180° C., or to 160° C. and for a time sufficient to produce a satisfactory conversion of the desired product, generally in the range of from 1 to 10 hours. It has been discovered that particle size of the product can be controlled by adjusting the relative amounts of cerium (III) nitrate and urea and by varying temperature. In general, higher temperatures and higher urea: cerium (III) nitrate ratios were found to provide smaller particles sizes.

The cerium (III) hydroxy carbonate solid prepared using the process of the present invention is advantageously washed with water to remove unwanted byproducts and starting materials. The washed product is then dried and isolated as a crystalline white powder. The product has a z-average particle size as measured using dynamic light scattering in the range of from 100 nm to 1000 nm.

The method of the present invention provides a high solids aqueous slurry of cerium (III) hydroxy carbonate nanoparticles (˜70 wt. %) in greater than 90% yield using inexpensive and biodegradable starting materials. Higher solids content is especially valuable because dilute solutions restrict the ability of paint formulators to control the addition of water.

Small particle sizes were achieved without polymer dispersants or chelating agents by carrying out the reaction using an excess of urea with a sustained reaction temperature at or above 110° C., preferably above 140° C.

### Example 1—Preparation of Cerium (III) Hydroxy Carbonate

Cerium (III) nitrate hexahydrate (30.0 g, 69.1 mmol, 1 eq.) and urea (25.0 g, 416 mmol, 6 eq.) were added to a round bottom flask equipped with a stirring bar, a condenser, and a Dean-Stark trap. The solid mixture was heated to 150° C. with stirring for 5 h. The mixture was allowed to cool to below 100° C., after which time water (80 g) was added to wash the material. The aqueous slurry was centrifuged at 18,500 rpm for 5 min, and the solids were separated, then subjected to three more rounds of washing and centrifugation. The solids were collected and allowed to dry at room temperature to yield 13.7 g (91.3% yield) of a white powder, identified by X-ray powder diffraction as hexagonal cerium (III) hydroxy carbonate. This material exhibited the same powder XRD pattern as observed in FIG. 7 of Cho.

Additional Examples 2-5 were prepared substantially as described in Example 1 except for changes in mole-to-mole ratios of cerium (III) nitrate hexahydrate: urea (Ce: Urea) and reaction temperatures. Comparative Example 1 was prepared substantially as described in Example 1 except the that the reaction temperature was maintained at 140° C. and PEG 600 Polyethylene Glycol (PEG 600, 4.0 g,) was combined with cerium (III) nitrate hexahydrate (20.0 g, 46.1 mmol, 1 eq.) and urea (8.33.0 g, 208 mmol, 3 eq.). The samples for were prepared for particle size measurement by diluting dried cerium (III) hydroxy carbonate powder (10 mg) DI water (5 mL). This mixture was sonicated for 2 min, after which time one drop of this mixture was diluted with 0.01 M NaCl solution (1 mL) then placed into a cuvette for analysis using a Malvern Zetasizer Nano-S90 instrument. The Z-average particle size was obtained after a 6-min method (three measurements of 2 min each). Table 1 illustrates the effect of temperature and starting material ratios on particle size (PS nm).

TABLE 1
Particle Sizes of Cerium (III) Hydroxy Carbonate

| | | | | | Std. |
|---|---|---|---|---|---|
| Example No. | Ce:Urea | Temp. ° C. | Dispersant? | PS nm | Dev. |
| Comp. Ex. 1 | 1:3 | 140 | PEG 600 | 590 | 115 |
| Ex. 1 | 1:3 | 150 | No | 978 | 56 |
| Ex. 2 | 1:6 | 130 | No | 307 | 2 |
| Ex. 3 | 1:6 | 150 | No | 208 | 4 |
| Ex. 4 | 1:6 | 170 | No | 146 | 2 |

The data demonstrate that particle size can be significantly reduced by increasing urea concentrations relative to cerium (III) carbonate concentrations and by increasing the reaction temperature.

1. A process comprising the step of contacting at a temperature in the range of from 110° C. to 200° C., and in the substantial absence of a polymer dispersant, a cerium (III) nitrate and urea to form cerium (III) hydroxy carbonate.

2. The process of claim 1 which is carried out with less than 1 weight percent of a polymer dispersant, based on the weight of the cerium (III) nitrate, wherein the mole-to-mole ratio of the cerium (III) nitrate to urea is in the range of from 1:3 to 1:20.

3. The process of claim 2 which is carried out at a temperature in the range of from 130° C. to 180° C., wherein cerium (III) nitrate is a hydrate of cerium (III) nitrate, and wherein the polymer dispersant is any or all of polyethylene glycol, a polymer functionalized with carboxylic acid groups, polyvinyl alcohol, or polyvinylpyrrolidone.

4. The process of claim 3 which is carried out at a temperature in the range of from 140° C. to 180° C., wherein the mole-to-mole ratio of the hydrate of cerium (III) nitrate to urea is in the range of from 1:5 to 1:10.

5. The process of claim 4 which is carried out with less than 0.1 weight percent of the polymer dispersant, based on the weight of hydrate of cerium (III) nitrate.

6. The process of claim 1 which is carried out in the substantial absence of a chelating agent that is capable of forming a capping ligand with the cerium (III) hydroxy carbonate.

7. The process of claim 5 which is carried out with less than 0.1 weight percent, based on the weight of the hydrate of cerium (III) nitrate, of a chelating agent, which is an amine carboxylic acid or a salt thereof, or an amine phosphonic acid or a salt thereof.

8. The process of claim 1 which is carried out under neat conditions.
